(19) United States
(12) Patent Application Publication
(10) Pub. No.: US 2025/0388428 A1
(43) Pub. Date: Dec. 25, 2025

(54) MEDIUM PROCESSING APPARATUS AND IMAGE FORMING SYSTEM

(71) Applicant: Masaaki KAWASAKI, Kanagawa (JP)

(72) Inventor: Masaaki KAWASAKI, Kanagawa (JP)

(73) Assignee: Ricoh Company, Ltd., Tokyo (JP)

(21) Appl. No.: 19/217,728

(22) Filed: May 23, 2025

(30) Foreign Application Priority Data
Jun. 24, 2024 (JP) 2024-101574

(51) Int. Cl. B65H 37/04; B41J 11/00; G03G 15/00

(52) U.S. Cl. CPC B65H 37/04; B41J 11/0015; G03G 15/6544; B65H 2301/51616; B65H 2301/5162; B65H 2801/27; G03G 2215/00801

(57) ABSTRACT

A medium processing apparatus includes a tray to stack multiple media including a medium, a crimp binder to crimp and bind the multiple media on the tray, and a crease former to form a crease on each of the multiple media on the tray before the crimp binder crimps and binds the multiple media.

### CROSS-REFERENCE TO RELATED APPLICATIONS

This patent application is based on and claims priority pursuant to 35 U.S.C. § 119 (a) to Japanese Patent Application No. 2024-101574, filed on Jun. 24, 2024, in the Japan Patent Office, the entire disclosure of which is hereby incorporated by reference herein.

### BACKGROUND

### Technical Field

Embodiments of the present disclosure relate to a medium processing apparatus and an image forming system incorporating the medium processing apparatus.

### Related Art

A medium processing apparatus is known that binds sheet-shaped multiple media, on which images are formed by an image forming apparatus, into a bundle of media. Since sheets of paper are widely known as an example of sheet-shaped media, a sheet bundle that is a stack of sheets of paper is used as an example of a bundle of sheet-shaped media. Some media processing apparatuses include a crimp binder that can perform so-called “crimp binding” without metal binding needles from a viewpoint of resource saving and reduction in environmental load. Specifically, the crimp binder sandwiches a sheet bundle (multiple media) with serrate binding teeth to press and deform the sheet bundle.

### SUMMARY

In an embodiment of the present disclosure, a medium processing apparatus includes a tray to stack multiple media including a medium, a crimp binder to crimp and bind the multiple media on the tray, and a crease former to form a crease on each of the multiple media on the tray before the crimp binder crimps and binds the multiple media.

In another embodiment of the present disclosure, an image forming system includes an image forming apparatus to form an image on a medium and the medium processing apparatus.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram of an overall configuration of an image forming system;

FIG. 2 is a diagram illustrating an internal structure of a post-processing apparatus according to a first embodiment of the present disclosure;

FIG. 3 is a schematic diagram illustrating an edge binder, viewed from an upstream side in a conveyance direction of a medium;

FIG. 4 is a schematic diagram illustrating a liquid applier of the edge binder of FIG. 3, viewed from a main scanning direction;

FIGS. 5A and 5B are diagrams each illustrating a configuration of a crimp binder of the edge binder of FIG. 3;

FIG. 6 is a block diagram illustrating a hardware configuration of the post-processing apparatus of FIG. 2, to control the operation of the post-processing apparatus;

FIG. 7 is a flowchart of a binding process performed by an edge binder;

FIGS. 8A, 8B, 8C, and 8D are diagrams each illustrating positions of a liquid applier and a crimper during the binding process of FIG. 7;

FIG. 9 is a schematic diagram illustrating a liquid applier of an edge binder according to a second embodiment of the present disclosure, viewed from the main scanning direction; FIGS. 10A and 10B are diagrams each illustrating an internal tray, an edge binder, and a crease former including a blade, viewed from a thickness direction of media;

FIGS. 11A and 11B are diagrams each illustrating relative positions of an image forming area, a liquid application area, a crimp binding area, and a crease;

FIGS. 12A and 12B are diagrams each illustrating a crease former according to a modification of the second embodiment;

FIGS. 13A and 13B are diagrams each illustrating a post-processing apparatus including controllers, according to a first modification of the second embodiment of the present disclosure; and

FIGS. 14A and 14B are diagrams each illustrating a post-processing apparatus including controllers, according to a second modification of the second embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Embodiments of Image Forming System 1

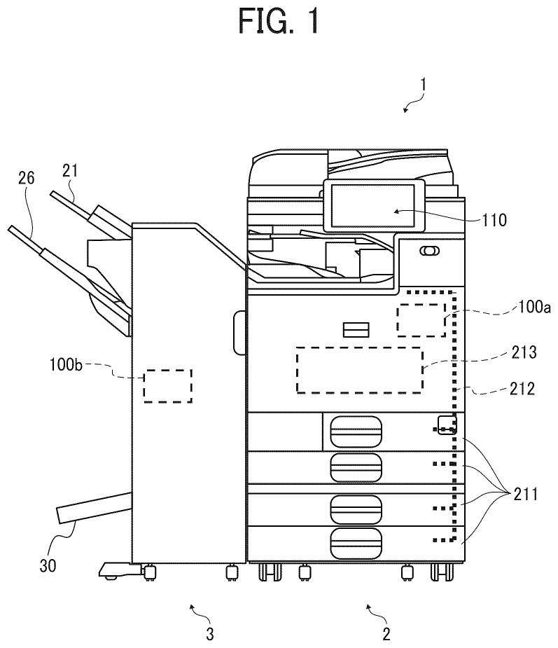

A description is given below of an image forming system 1 with reference to the drawings. FIG. 1 is a diagram illustrating an overall configuration of an image forming system 1. The image forming system 1 has a function of forming an image on a sheet P as a sheet-shaped medium and a function of performing a post-processing operation on the sheet P as a process after the image is formed on the sheet P. As illustrated in FIG. 1, the image forming system 1 includes an image forming apparatus 2 having the image forming function and a post-processing apparatus 3 serving as a medium processing apparatus having the post-processing function. In the image forming system 1, the image forming apparatus 2 and the post-processing apparatus 3 operate in conjunction with each other.

In the present embodiment, the sheet-shaped medium or sheet-shaped medium to be processed in the image forming system 1 is described on the assumption that the medium is a sheet of paper. However, the object to be processed according to the embodiments of the present disclosure is not limited to a sheet of paper. For example, any type of medium can be used as long as an image can be formed on the medium according to an image forming process. Examples of the medium include a medium that can be an object of a folding process or a binding process, and the material and specification of the medium are not limited to any particular material and specification.

The image forming apparatus 2 forms an image on a sheet P and ejects the sheet P, on which the image has been formed, to the post-processing apparatus 3. The image forming apparatus 2 includes a sheet tray 211 that accommodates sheets P, a conveyor 212 that conveys the sheets P accommodated in the sheet tray 211, and an image former 213 that forms an image on each of the sheets P conveyed by the conveyor 212. The image former 213 may be an inkjet system that forms an image using ink or an electrophotographic system that forms an image using toner. The image forming apparatus 2 also includes a controller 100a that controls various operations of the conveyor 212 and the image former 213. Since the image forming apparatus 2 has a typical configuration, a detailed description of the configuration and functions of the image forming apparatus 2 are omitted.

Sheets of paper are widely known as an example of sheet-shaped media. In the following description, a sheet-shaped medium as a medium to be processed is referred to as a sheet P. In addition, in the following description, a bundle of sheets of paper as a plurality of media is referred to as a sheet bundle Pb.

A description is given of the post-processing apparatus 3 according to a first embodiment of the present disclosure.

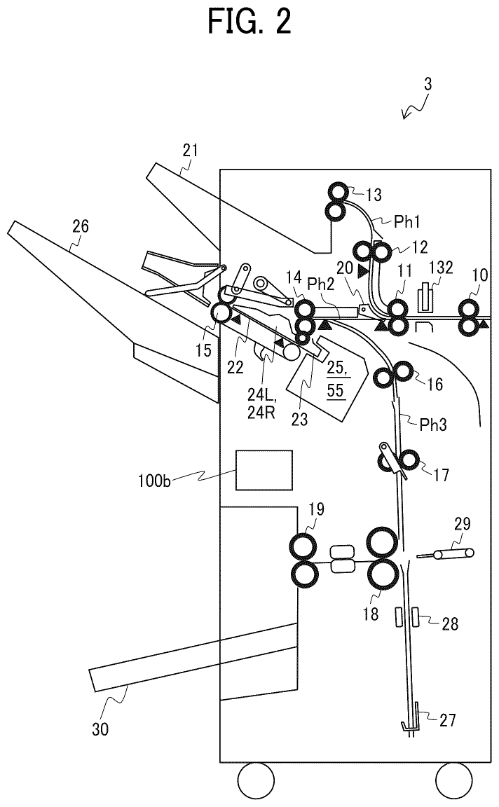

FIG. 2 is a diagram illustrating an internal structure of the post-processing apparatus 3 according to the first embodiment. The post-processing apparatus 3 has a function that performs post-processing on the sheet P on which an image has been formed by the image forming apparatus 2.

An example of the post-processing according to the present embodiment is a binding process as a “crimp binding” that binds, without staples, multiple sheets P on each of which an image is formed as a bundle of sheets, which may be referred to as a sheet bundle Pb. Another example of the post-processing according to the present embodiment is a binding process as a “staple binding” that binds, with staples, the multiple sheets P on each of which an image is formed as a bundle of sheets P (i.e., sheet bundle Pb).

A description is given of liquid application in the crimp binding. However, liquid application performed in the staple binding is similar to the liquid application in the crimping process. In the following description, the term “binding process” indicates both the crimp binding and the staple binding, and is not limited to a binding method (whether a binding needle is used or a pressing and deforming process is performed).

More specifically, the crimp binding according to the present embodiment is a process called “crimp binding” to apply pressure to the binding position corresponding to a part of the sheet bundle Pb to deform (pressure-deform) the binding position and bind the sheet bundle Pb. The binding that can be executed by the post-processing apparatus 3 includes edge binding and saddle binding. The edge binding is a process to bind an end of the sheet bundle Pb. The saddle binding is a process to bind the center of the sheet bundle Pb.

The post-processing apparatus 3 includes conveyance roller pairs 10 to 19 (an example of conveyors), a switcher 20, and a controller 100b (an example of a controller). The controller 100b controls the operations of, for example, the conveyance roller pairs 10 to 19, and the switcher 20. The controller 100b will be described later in detail. The conveyance roller pairs 10 to 19 convey, inside the post-processing apparatus 3, a sheet P supplied from the image forming apparatus 2. Specifically, the conveyance roller pairs 10 to 13 convey the sheet P along a first conveyance path Ph1. The conveyance roller pairs 14 and 15 convey the sheet P along a second conveyance path Ph2. The conveyance roller pairs 16 to 19 convey the sheet P along a third conveyance path Ph3. A hole punch 132 is disposed between the conveyance roller pairs 10 and 11. The hole punch 132 punches holes in the sheet P conveyed by the conveyance roller pairs 10 and 11.

The first conveyance path Ph1 is a path extending from a supply port through which the sheet P is supplied from the image forming apparatus 2 to a first output tray 21. The second conveyance path Ph2 is a path branching from the first conveyance path Ph1 between the conveyance roller pairs 11 and 14 in a conveyance direction and extending to a second output tray 26 via an internal tray 22. The third conveyance path Ph3 is a path branching from the first conveyance path Ph1 between the conveyance roller pairs 11 and 14 in the conveyance direction and extending to an output tray 30.

The switcher 20 is disposed at a branching position of the first conveyance path Ph1 and the second conveyance path Ph2. The switcher 20 can be switched between a first position and a second position. The switcher 20 in the first position guides the sheet P to be ejected to the first output tray 21 through the first conveyance path Ph1. The switcher 20 in the second position guides the sheet P conveyed through the first conveyance path Ph1 to the second conveyance path Ph2. When a trailing end of the sheet P entering the second conveyance path Ph2 passes through the conveyance roller pair 11, the conveyance roller pair 14 is rotated in reverse to guide the sheet P to the third conveyance path Ph3. The post-processing apparatus 3 further includes multiple sensors that detect the positions of the sheet P in the first conveyance path Ph1, the second conveyance path Ph2, and the third conveyance path Ph3. Each of the multiple sensors is indicated by black triangles in FIG. 2.

The post-processing apparatus 3 includes the first output tray 21 as a first stacking tray. The sheet P that is ejected through the first conveyance path Ph1 rests on the first output tray 21. Among the sheets P supplied from the image forming apparatus 2, the sheets P that are not bound are ejected to the first output tray 21.

The post-processing apparatus 3 further includes the internal tray 22 as a placement tray, an end fence 23, side fences 24L and 24R, an edge binder 25, a staple binder 55, and the second output tray 26 as a second stacking tray. The internal tray 22, the end fence 23, the side fences 24L and 24R, the edge binder 25, and the staple binder 55 perform edge binding on the sheet bundle Pb including multiple sheets P conveyed from the second conveyance path Ph2 to the internal tray 22. Among the sheets P supplied from the image forming apparatus 2, the sheet bundle Pb subjected to the edge binding is ejected to the second output tray 26.

The edge binding includes parallel binding, oblique binding, and vertical binding. The parallel binding is a process to perform binding along one side of the sheet bundle Pb parallel to the main scanning direction. The oblique binding is a process to perform binding at a corner of the sheet bundle Pb. The vertical binding is a process to perform binding at multiple positions spaced apart from each other in the width direction along one side of the sheet bundle Pb parallel to a conveyance direction in which the sheet bundle Pb is conveyed.

In the following description, a direction in which the sheet P is conveyed from the conveyance roller pair 15 toward the end fence 23 is defined as a conveyance direction. In other words, the conveyance direction herein corresponds to a direction in which the sheet P that has been output from the image forming apparatus 2 is moved toward the second output tray 26 by, for example, the conveyance roller pair 10, is changed to move toward the end fence 23 by the conveyance roller pair 15 in a direction different from the above-described direction. The direction that is orthogonal to both the conveyance direction and a thickness direction of the sheet P is defined as a main scanning direction or a width direction of the sheet P.

The sheets P that are sequentially conveyed through the second conveyance path Ph2 are temporarily placed on the internal tray 22 serving as a placement tray. The end fence 23 aligns the position, in the conveyance direction, of the sheet P or the sheet bundle Pb supported on the internal tray 22. The side fences 24L and 24R align the position, in the main scanning direction, of the sheet P or the sheet bundle Pb supported on the internal tray 22. The edge binder 25 and the staple binder 55 bind an end of the sheet bundle Pb aligned by the end fence 23 and the side fences 24L and 24R. Then, the conveyance roller pair 15 ejects the sheet bundle Pb subjected to the edge binding to the second output tray 26.

The post-processing apparatus 3 further includes an end fence 27, a saddle binder 28, a sheet folding blade 29, and the output tray 30. The end fence 27, the saddle binder 28, and the sheet folding blade 29 perform saddle binding on a sheet bundle Pb including the sheets P that are conveyed through the third conveyance path Ph3. Among the sheets P supplied from the image forming apparatus 2, the sheet bundle Pb subjected to the saddle binding is ejected to the output tray 30.

The end fence 27 aligns the positions of the sheets P that are sequentially conveyed through the third conveyance path Ph3, in the conveyance direction in which the sheets P are conveyed. The end fence 27 can move between a binding position where the end fence 27 causes the center of the sheet bundle Pb to face the saddle binder 28 and a folding position where the end fence 27 causes the center of the sheet bundle Pb to face the sheet folding blade 29. The saddle binder 28 binds the center of the sheet bundle Pb aligned by the end fence 27 at the binding position. The sheet folding blade 29 folds, in half, the sheet bundle Pb supported on the end fence 27 at the folding position and causes the conveyance roller pair 18 to nip the sheet bundle Pb. The conveyance roller pairs 18 and 19 eject the sheet bundle Pb subjected to the saddle binding to the output tray 30.

A description is given below of the edge binder 25.

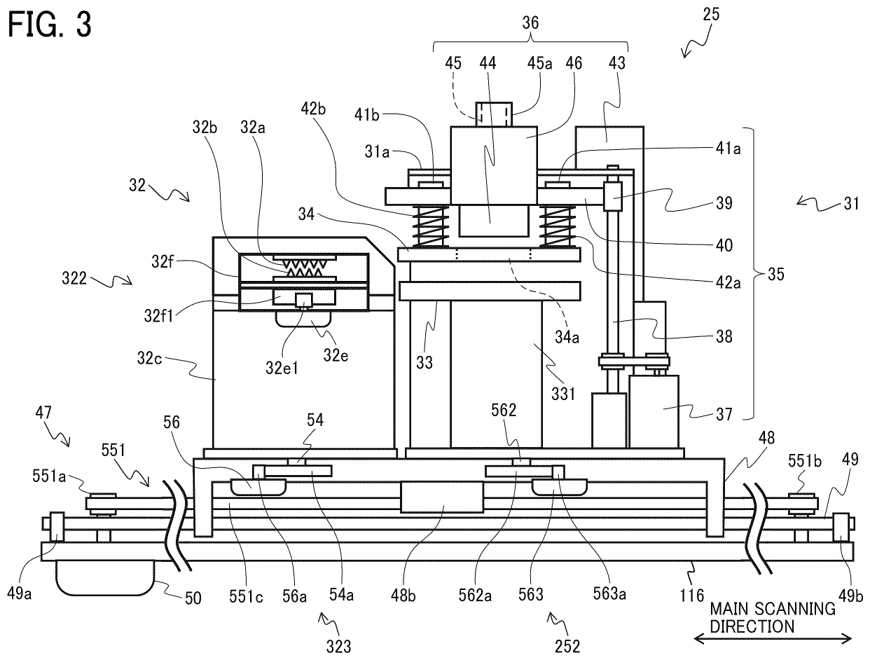

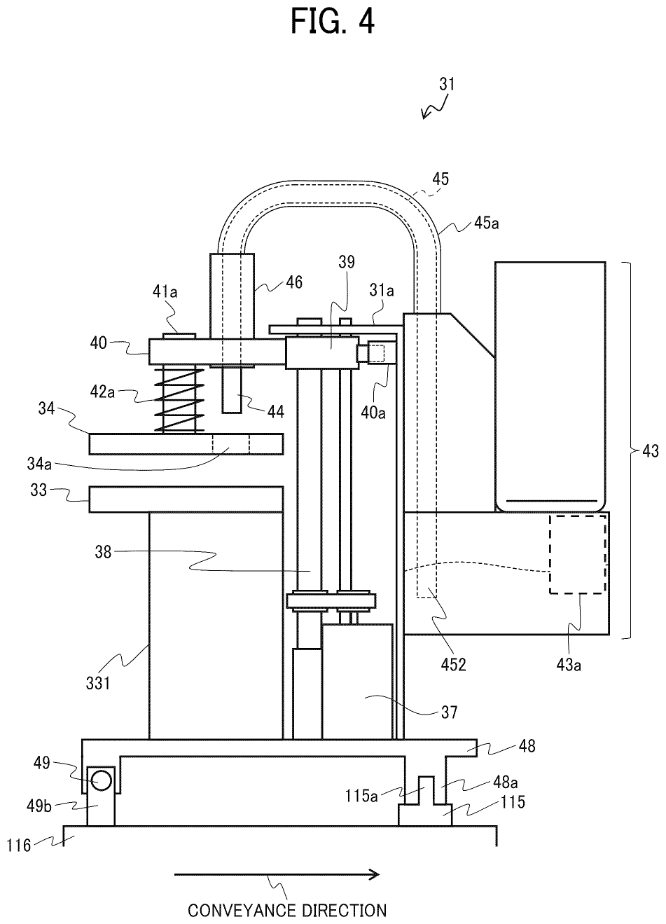

FIG. 3 is a schematic diagram illustrating the edge binder 25 that performs liquid application and the crimp binding, as viewed from an upstream side thereof in the conveyance direction. FIG. 4 is a schematic diagram illustrating a liquid applier 31 of the edge binder 25, viewed from the main scanning direction. As illustrated in FIGS. 3 and 4, the edge binder 25 includes the liquid applier 31 that applies liquid to the sheets P, and a crimp binder 32, which is an example of a post-processing device, performs the crimp binding on the sheet bundle Pb. The liquid applier 31 and the crimp binder 32 are disposed adjacent to each other in the main scanning direction downstream from the internal tray 22 in the conveyance direction.

As illustrated in FIG. 4, the liquid applier 31 as a liquid applier applies the liquid stored in a first liquid storage tank 43 as a liquid storage, to the sheet P or the sheet bundle Pb supported on the internal tray 22. Applying liquid to a sheet P or a sheet bundle Pb by the liquid applier 31 and the operation of the liquid applier 31 when applying liquid are referred to as liquid application in the following description. The liquid application operation of the liquid applier 31 accompanied by the control process is referred to as a liquid application process.

More specifically, the liquid that is stored in the first liquid storage tank 43 as liquid for the liquid application includes, as a main component, the liquid state of a compound of hydrogen and oxygen compound represented by the chemical formula H₂O. The temperature condition of the liquid hydrogen-oxygen compound is not limited. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid that is stored in the first liquid storage tank 43 may include an additive in addition to the main component. The liquid that is stored in the first liquid storage tank 43 may include residual chlorine used as tap water. Preferably, for example, the liquid that is stored in the first liquid storage tank 43 may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the liquid application.

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet bundle Pb, in comparison with a liquid of which the main component is not water (liquid).

Next, a description is given of a configuration of the liquid applier 31.

As illustrated in FIGS. 3 and 4, the liquid applier 31 can be moved in the main scanning direction together with the crimp binder 32 by the driving force transmitted from an edge-binder moving motor 50.

The liquid applier 31 includes a lower pressure plate 33 serving as a placement tray for the sheet P or the sheet bundle Pb, an upper pressure plate 34, a liquid applier movement assembly 35, and a liquid application assembly 36. The components of the liquid applier 31 (the lower pressure plate 33, the upper pressure plate 34, the liquid applier movement assembly 35, and a liquid applier movement motor 37) are held by a liquid application frame 31a and a base 48.

As illustrated in FIG. 3, the liquid applier 31 includes a liquid applier pivot assembly 252. The liquid applier pivot assembly 252 includes a liquid-applier pivot motor 563, an output gear 563a, and a drive transmission gear 562a. A liquid applier rotary shaft 562 that includes the drive transmission gear 562a is fixed to a bottom face of the liquid application frame 31a that holds the components of the liquid applier 31. The liquid applier rotary shaft 562 and the drive transmission gear 562a are held by the base 48 on which the liquid application frame 3 la is disposed, so as to be rotatable in the forward and reverse directions.

The drive transmission gear 562a meshes with the output gear 563a of the liquid-applier pivot motor 563. The liquid applier 31 can be rotated in the forward and reverse directions about the liquid applier rotary shaft 562 on the base 48 by a driving force transmitted from the liquid-applier pivot motor 563 to the liquid applier rotary shaft 562 via the output gear 563a and the drive transmission gear 562a.

The lower pressure plate 33 and the upper pressure plate 34 are disposed downstream from the internal tray 22 in the conveyance direction. The sheets P or the sheet bundle Pb that is supported on the internal tray 22 is also placed on the lower pressure plate 33. The lower pressure plate 33 is disposed on a lower pressure plate holder 331. The upper pressure plate 34 is movable in the thickness direction of the sheet P or the sheet bundle Pb at a position where the upper pressure plate 34 faces the sheet P or the sheet bundle Pb supported on the internal tray 22.

In other words, the lower pressure plate 33 and the upper pressure plate 34 are disposed to face each other in the thickness direction of the sheet P or the sheet bundle Pb with the sheet P or the sheet bundle Pb supported on the internal tray 22 interposed between the lower pressure plate 33 and the upper pressure plate 34. In the following description, the thickness direction of the sheet P or the sheet bundle Pb may be referred to simply as the thickness direction. The upper pressure plate 34 has a through hole 34a penetrating in the thickness direction at a position where the through hole 34a faces a liquid application member 44 held via a joint 46 attached to a base plate 40. The liquid application member 44 is one end of a liquid supply member 45 (liquid absorber) described below and corresponds to an end of the liquid supply member 45.

The liquid applier movement assembly 35 moves the upper pressure plate 34, the base plate 40, the joint 46, and the liquid application member 44 in the thickness direction of the sheet P or the sheet bundle Pb. The liquid applier movement assembly 35 according to the present embodiment moves the upper pressure plate 34, the base plate 40, the joint 46, and the liquid application member 44 in conjunction with each other with the single liquid applier movement motor 37. The liquid applier movement assembly 35 includes, for example, the liquid applier movement motor 37, a trapezoidal screw 38, a nut 39, the base plate 40, columns 41a and 41b, and coil springs 42a and 42b.

The liquid applier movement motor 37 generates driving force to move the upper pressure plate 34, the base plate 40, the joint 46, and the liquid application member 44. The trapezoidal screw 38 extends in the thickness direction of the sheet P or the sheet bundle Pb and is provided with the liquid application frame 31a such that the trapezoidal screw 38 is rotatable in the forward and reverse directions. The trapezoidal screw 38 is coupled to an output shaft of the liquid applier movement motor 37 via, for example, a pulley and a belt. The nut 39 is screwed to the trapezoidal screw 38. The trapezoidal screw 38 is rotated in the forward and reverse directions by the driving force transmitted from the liquid applier movement motor 37. The rotation of the trapezoidal screw 38 causes the nut 39 to reciprocate on the trapezoidal screw 38.

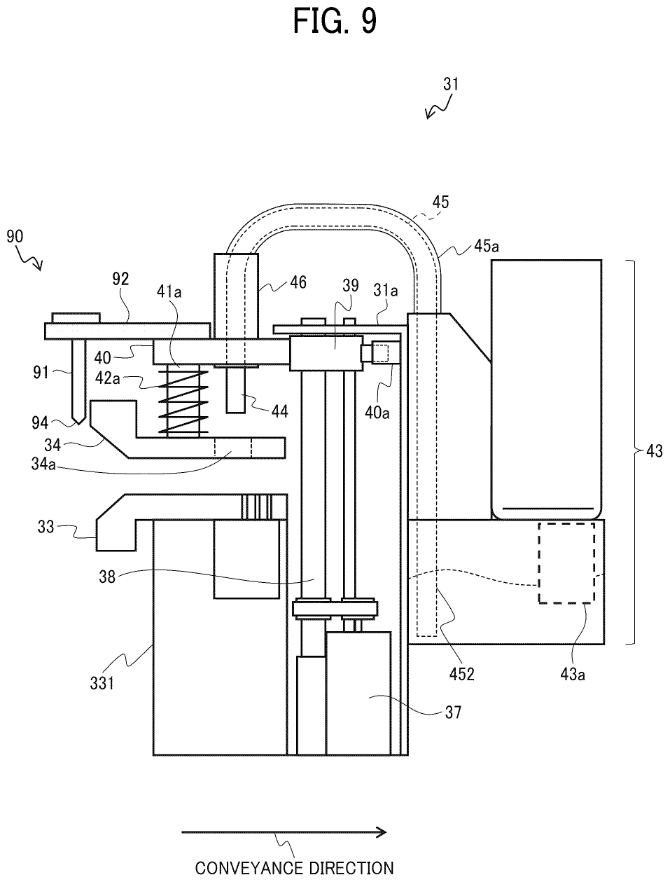

The base plate 40 is positioned apart from the upper pressure plate 34. The base plate 40 holds the liquid application member 44 with the end of the liquid application member 44 protruding from the base plate 40 toward the upper pressure plate 34. The base plate 40 is coupled to the trapezoidal screw 38 via the nut 39 such that base plate 40 can reciprocate along the trapezoidal screw 38 as the trapezoidal screw 38 rotates in the forward and reverse directions. The position of the base plate 40 in the vertical direction is detected by a movement sensor 40a (see FIG. 9).

The columns 41a and 41b project from the base plate 40 toward the upper pressure plate 34 around the end of the liquid application member 44. The columns 41a and 41b can relatively move with respect to the base plate 40 in the thickness direction. The columns 41a and 41b hold the upper pressure plate 34 with the respective ends closer to the lower pressure plate 33 than the other ends of the columns 41a and 41b. The other ends of the columns 41a and 41b opposite the ends closer to the lower pressure plate 33 are provided with stoppers that prevent the columns 41a and 41b from being removed from the base plate 40.

The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid application assembly 36 applies liquid to the sheet P or the sheet bundle Pb supported on the internal tray 22. Specifically, the liquid application assembly 36 brings the liquid application member 44 into contact with the sheet P or the sheet bundle Pb to apply the liquid to at least one sheet P of the sheet bundle Pb.

The liquid application assembly 36 includes the liquid application member 44, the liquid supply member 45, the first liquid storage tank 43, and the joint 46. The first liquid storage tank 43 stores the liquid to be supplied to the sheet P or the sheet bundle Pb. The liquid stored in the first liquid storage tank 43 is detected by a liquid level sensor 43a serving as a liquid detector.

The liquid application member 44 applies the liquid stored in the first liquid storage tank 43 to the sheet P or the sheet bundle Pb. The liquid application member 44 is held by the base plate 40 with the end of the liquid application member 44 facing the upper pressure plate 34.

Further, the liquid application member 44 is made of a material having a relatively high liquid absorption. For example, the liquid application member 44 is made of an open cell foam that can contain liquid. The liquid application member 44 is not limited to a particular kind provided that the liquid application member 44 is made of a material having a property of absorbing and holding the liquid and has a property of being crushed according to a pressing force applied when the liquid application member 44 is in contact with the sheet P. For example, the liquid application member 44 may be a foam material such as a sponge or a fiber material that can absorb liquid by capillary action. The liquid supply member 45 (liquid absorber) is an elongated member having an immersion portion 452. A base end of the immersion portion 452 is immersed in the liquid stored in the first liquid storage tank 43 and another end of the immersion portion 452 is coupled to the liquid application member 44. Like the liquid application member 44, for example, the liquid supply member 45 is made of a material having a relatively high liquid absorption. Accordingly, the liquid absorbed from the immersion portion 452 of the liquid supply member 45 is supplied to the liquid application member 44 by the capillary action. In other words, the liquid stored in the first liquid storage tank 43 is absorbed up from the immersion portion 452 of the liquid supply member 45, and the absorbed liquid is supplied to the liquid application member 44 coupled to the other end of the liquid supply member 45 through the liquid supply member 45.

As described above, the liquid absorbed from the immersion portion 452 of the liquid supply member 45 is supplied to the liquid application member 44 through the liquid supply member 45, and the liquid application member 44 contacts the upper face of an uppermost sheet P of the sheets P or the sheet bundle Pb to apply the liquid.

Although the liquid supply member 45 and the liquid application member 44 are separate bodies in the above description, the liquid supply member 45 and the liquid application member 44 may be integrally formed of a material having similar properties (for example, a material having a high liquid absorption rate). In other words, the liquid application member 44 may be part of the liquid supply member 45. In such a case, liquid can be supplied from the liquid supply member 45 to the liquid application member 44 more smoothly by the capillary action, and cost reduction can be achieved.

A protector 45a is an elongated cylindrical body (e.g., a tube) that is fitted around the liquid supply member 45. Such a configuration prevents the liquid absorbed by the liquid supply member 45 from leaking or evaporating. The liquid supply member 45 and the protector 45a are made of a flexible material. The joint 46 holds the liquid application member 44 and is disposed on the base plate 40. Accordingly, even when the liquid application member 44 is moved by the liquid applier movement assembly 35 in a direction orthogonal to the conveyance direction and the main scanning direction, the liquid application member 44 keeps projecting from the base plate 40 toward the upper pressure plate 34 with the end of the liquid application member 44 facing the upper pressure plate 34.

In the liquid application process, the controller 100b controls the amount of driving force of the liquid applier movement motor 37. By so doing, the controller 100b controls the amount of movement (pressing amount) of the liquid application member 44 to the sheet P or the sheet bundle Pb. By controlling the amount of movement of the liquid application member 44 relative to the sheet P or the sheet bundle Pb, the size of the area (contact area) where the liquid application member 44 contacts the sheet P or the sheet bundle Pb or the contact time of the liquid application member 451 can be adjusted. With this adjustment, the amount of liquid applied to the sheet P or the sheet bundle Pb and the spread of the liquid in the liquid application process can be adjusted.

A description is given of the configuration of the crimp binder 32.

As illustrated in FIG. 3, the crimp binder 32 as a post-processing device presses and deforms at least a portion, i.e., a liquid application position, of the sheet bundle Pb, to which liquid has been applied by the liquid applier 31, by serrated upper crimping teeth 32a and lower crimping teeth 32b, and crimps the sheets P at the liquid application position to bind the sheet bundle Pb. In short, the crimp binder 32 binds the sheet bundle Pb without staples. The components of the crimp binder 32 such as the upper crimping teeth 32a and the lower crimping teeth 32b are disposed on a crimping frame 32c. In the following description, such a way of pressing and deforming a predetermined position on the sheet bundle Pb to bind the sheet bundle Pb may be referred to as the crimp binding. In other words, the crimp binder 32 crimps and binds the sheet bundle Pb or performs the crimp binding on the sheet bundle Pb. The crimping and binding operation of the crimp binder 32 that involves control processing is referred to as a crimp binding process.

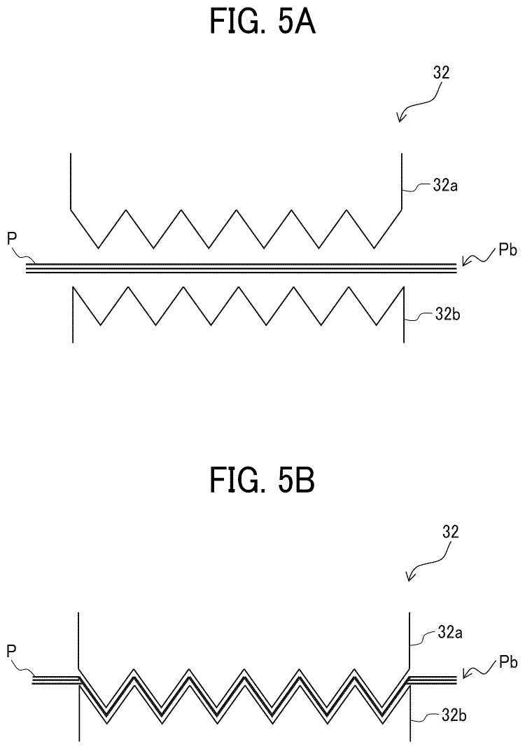

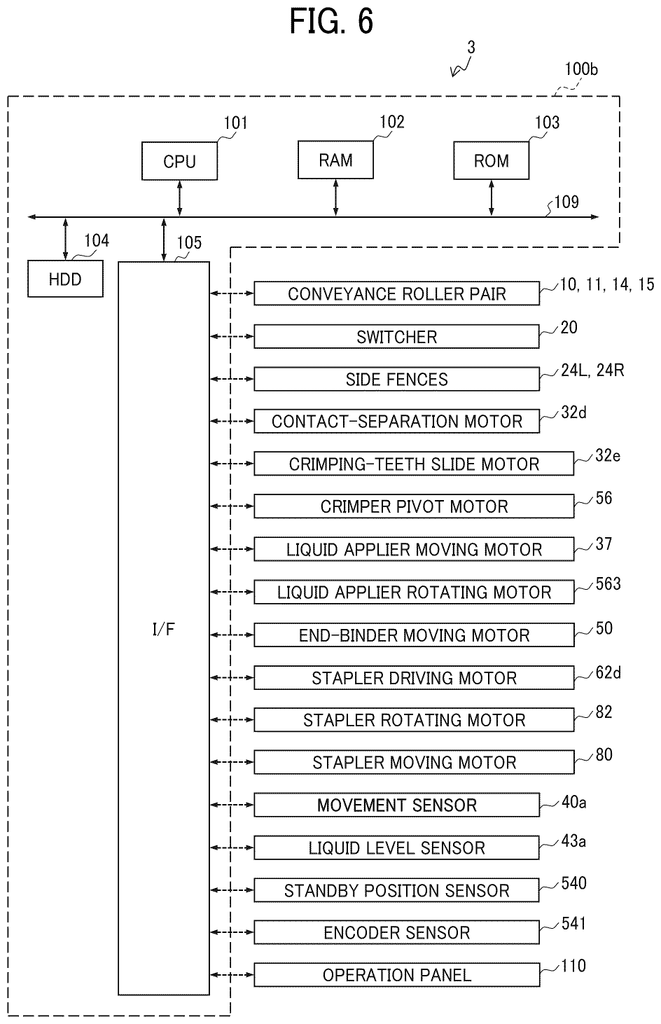

FIGS. 5A and 5B are schematic diagrams each illustrating a configuration of the crimp binder 32. As illustrated in FIGS. 5A and 5B, the crimp binder 32 includes the upper crimping teeth 32a and the lower crimping teeth 32b. The upper crimping teeth 32a and the lower crimping teeth 32b are disposed to face each other in the thickness direction of the sheet bundle Pb to sandwich the sheet bundle Pb supported on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from those of the lower crimping teeth 32b such that the upper crimping teeth 32a are engaged with the lower crimping teeth 32b. The upper crimping teeth 32a and the lower crimping teeth 32b are brought into contact with and separated from each other by the driving force of a contact-separation motor 32d (see FIG. 6).

In the process of supplying the sheets P of the sheet bundle Pb to the internal tray 22, the upper crimping teeth 32a and the lower crimping teeth 32b are separated from each other as illustrated in FIG. 5A. When all the sheets P of the sheet bundle Pb are supported on the internal tray 22, the upper crimping teeth 32a and the lower crimping teeth 32b are engaged with each other as illustrated in FIG. 5B by the driving force of the contact-separation motor 32d to press and deform the sheet bundle Pb in the thickness direction. As a result, the sheet bundle Pb that has been supported on the internal tray 22 is crimped and bound. The sheet bundle Pb thus crimped and bound is ejected to the second output tray 26 by the conveyance roller pair 15.

The configuration of the crimp binder 32 as a crimping assembly is not limited to the configuration of a moving assembly exemplified in the present embodiment and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or that rotates the forward and backward directions. Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the crimp binder 32 includes a crimping teeth slider 322. The crimping teeth slider 322 includes a crimping teeth slider motor 32e, a pinion gear 32e1, a rack 32f1, and a crimping teeth frame 32f, which are described below. The upper crimping teeth 32a and the lower crimping teeth 32b are disposed on the crimping teeth frame 32f. The crimping teeth frame 32f and the rack 32f1 are integrally formed, and the rack 32f1 meshes with the pinion gear 32e1 described below. The crimping teeth frame 32f is attached to the crimping frame 32c so as to be movable in the main scanning direction. The crimping teeth slider motor 32e generates a driving force to move the crimping teeth frame 32f in the main scanning direction. The pinion gear 32e1 is disposed on the output-shaft of the crimping teeth slider motor 32e. Rotating the crimping teeth slider motor 32e in the forward and reverse directions rotates the pinion gear 32e1 in the forward and reverse directions. Rotating the pinion gear 32e1 in the forward and reverse directions reciprocates the rack 32f1 meshing with the pinion gear 32e1 in the main scanning direction with respect to the crimping frame 32c. As a result, the crimping teeth frame 32f provided integrally with the rack 32f1 also reciprocates in the main scanning direction with respect to the crimping frame 32c. In other words, rotating the crimping teeth slider motor 32e in the forward and reverse directions moves the upper crimping teeth 32a and the lower crimping teeth 32b disposed on the crimping teeth frame 32f in the main scanning direction. The above-described configuration enables the upper crimping teeth 32a and the lower crimping teeth 32b to perform multiple binding operations while shifting the positions in the main scanning direction with respect to the sheet bundle Pb.

In the main scanning direction, the movement amount of the upper crimping teeth 32a and the lower crimping teeth 32b of the crimping assembly is set to be equal to the length of crimping mark formed by the crimp binding operation of the upper crimping teeth 32a and the lower crimping teeth 32b. At this time, the upper crimping teeth 32a and the lower crimping teeth 32b perform crimp binding operations before and after the movement in the main scanning direction. In other words, when the length of the crimping mark formed by the crimp binding process performed by the upper crimping teeth 32a and the lower crimping teeth 32b is 10 mm, the movement amount of the upper crimping teeth 32a and the lower crimping teeth 32b in the main scanning direction is set to be 10 mm. By so doing, performing the first crimping binding operation before the movement in the main scanning direction and the second crimp binding operation after the movement in the main scanning direction allows the length of the crimping mark to be 20 mm. Accordingly, the binding force of the crimp binder 32 increases by about two times.

As illustrated in FIG. 3, the crimp binder 32 includes a crimper pivot assembly 323 as a post-processing device pivot assembly. The crimper pivot assembly 323 includes a crimper pivot motor 56, an output gear 56a, and a drive transmission gear 54a, which are described below. A crimper rotary shaft 54 that includes the drive transmission gear 54a is fixed to the bottom of the crimping frame 32c holding the components of the crimp binder 32.

The crimper rotary shaft 54 and the drive transmission gear 54a are held by the base 48 on which the crimping frame 32c is disposed so as to be rotatable in the forward and reverse directions. The drive transmission gear 54a meshes with the output gear 56a of the crimper pivot motor 56. The crimp binder 32 can be rotated in the forward and reverse directions about the crimper rotary shaft 54 on the base 48 by a driving force transmitted from the crimper pivot motor 56 to the crimper rotary shaft 54 via the output gear 56a and the drive transmission gear 54a.

As illustrated in FIG. 3, the edge binder 25 includes an edge-binder movement assembly 47 as a mover.

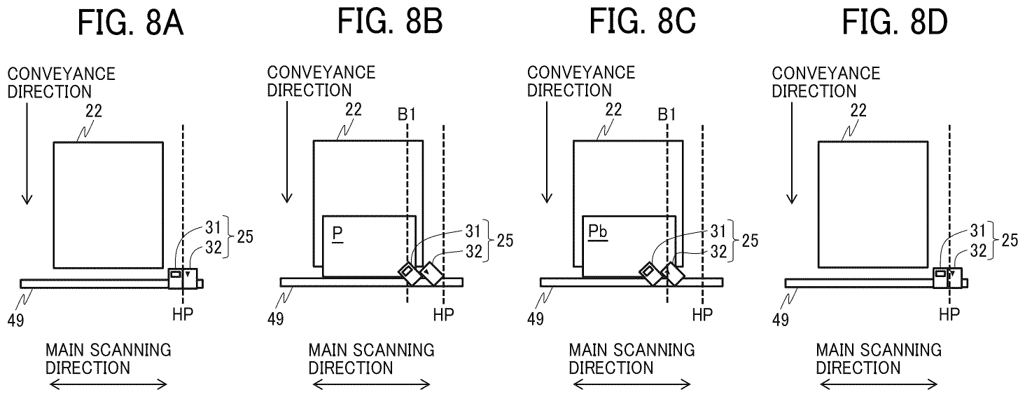

The edge-binder movement assembly 47, as a mover, moves the edge binder 25, specifically, the liquid applier 31 and the crimp binder 32, in the main scanning direction along a downstream end, in the conveyance direction, of the sheet P supported on the internal tray 22. The edge-binder movement assembly 47 includes, for example, the base 48, a guide shaft 49, the edge-binder moving motor 50, and a driving force transmission assembly 551 that transmits the driving force of the edge-binder moving motor 50 to the base 48, and a standby-position sensor 540 (see FIG. 8).

The liquid applier 31 and the crimp binder 32 are attached to the base 48 such that the liquid applier 31 and the crimp binder 32 are adjacent to each other in the main scanning direction. As illustrated in FIGS. 3 and 4, the guide shaft 49 is held by guide shaft brackets 49a and 49b disposed in the main-scanning direction upstream from a binder assembly base 116 in the conveyance direction. As illustrated in FIG. 3, the guide shaft 49 extends in the main scanning direction on the binder assembly base 116. A guide rail 115 extends in the main scanning direction, downstream from the binder assembly base 116 in the conveyance direction. As illustrated in FIG. 4, the guide rail 115 includes a fitting target portion 115a that fits a fitting portion 48a of the base 48 in the main scanning direction. In other words, the base 48 is movably held by the guide shaft 49 and the guide rail 115 in the main scanning direction on the binder assembly base 116.

The edge-binder moving motor 50 generates a driving force to move the edge binder 25. The driving force transmission assembly 551 transmits the driving force of the edge-binder moving motor 50 to the base 48 via pulleys 551a and 551b, a timing belt 551c, and a fastener 48b that fastens the base 48 and the timing belt 551c. As a result, the liquid applier 31 and the crimp binder 32 integrated by the base 48 move in the main scanning direction along the guide shaft 49.

The edge-binder moving motor 50 according to the present embodiment is, for example, a servo motor that can stop the edge binder 25 at a target position without returning the edge binder 25 to an origin position (for example, a standby position HP described below) every time the edge binder 25 is moved. The target position of the edge binder 25 is a position at which the binding process is performed on the sheet bundle Pb by the crimp binder 32.

The post-processing apparatus 3 further includes a standby-position sensor 540 and an encoder sensor 541. The standby-position sensor 540 is, for example, a light-shielding optical sensor (see FIG. 6) to detect that the edge binder 25 has reached a standby position HP (HP means a home position) (see FIG. 8A). The encoder sensor 541 (see FIG. 6) is attached to an output shaft of the edge-binder moving motor 50. The controller 100b, which is described below, detects that the edge binder 25 has reached the standby position HP, based on a detection result of the standby-position sensor 540. The controller 100b also counts pulse signals output from the encoder sensor 541 to ascertain the current position of the edge binder 25 moved from the standby position HP.

However, a specific method of stopping the edge binder 25 at the target position without returning the edge binder 25 to the origin position is not limited to the aforementioned example. As another example, the post-processing apparatus 3 may include a sensor that detects that the edge binder 25 has reached a predetermined target position.

In the above description, the staple binder 25 has a configuration in which the edge binder 25 and the crimp binder 32 move along the guide shaft 49 as a single unit. However, the embodiments of the present disclosure are not limited to the above-described configuration. For example, the crimp binder 32 and the liquid applier 31 may move separately from each other.

The position, i.e., the liquid application position, to which liquid is applied on a sheet P or a sheet bundle Pb by the liquid applier 31 corresponds to the binding position on the sheet bundle Pb to be crimped by the crimp binder 32.

A description is given below of a control block configuration of the post-processing apparatus 3.

The control block configuration of the post-processing apparatus 3 according to a first embodiment is described with reference to FIG. 6. FIG. 6 is a block diagram illustrating a hardware configuration for executing control processing in the post-processing apparatus 3 according to the first embodiment. As illustrated in FIG. 6, the post-processing apparatus 3 includes a central processing unit (CPU) 101, a random access memory (RAM) 102, a read only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3. The RAM 102 is a volatile storage medium that allows high speed reading and writing of data, and is used as a working area when the CPU 101 processes data. The ROM 103 is a read-only non-volatile storage medium that stores programs such as firmware. The HDD 104 is a non-volatile storage medium that allows data to be read and written and has a relatively large storage capacity. The HDD 104 stores, e.g., an operating system (OS), various control programs, and application programs.

In the post-processing apparatus 3, an arithmetic function of the CPU 101 processes a control program stored in the ROM 103 and an information processing program (or application program) loaded into the RAM 102 from a storage medium such as the HDD 104. Such processing configures a software controller including various functional modules of the post-processing apparatus 3. The software controller that is thus configured cooperates with hardware resources of the post-processing apparatus 3 to construct functional blocks that implement functions of the post-processing apparatus 3. In other words, the CPU 101, the RAM 102, the ROM 103, the HDD 104, and the I/F 105 constitute at least part of the controller 100b serving as a control device that controls the operation of the post-processing apparatus 3.

The I/F 105 is an interface that connects the conveyance roller pairs 10, 11, 14, and 15, the switcher 20, the side fences 24L and 24R, the contact-separation motor 32d, the crimper pivot motor 56, the liquid applier movement motor 37, the liquid-applier pivot motor 563, the edge-binder moving motor 50, a stapler drive motor 62d, a stapler pivot motor 82, a staple binder movement motor 80, the movement sensor 40a, the liquid level sensor 43a, the standby-position sensor 540, the encoder sensor 541, and an operation panel 110 to the common bus 109.

The controller 100b controls, via the I/F 105, the operations of the conveyance roller pairs 10, 11, 14, and 15, the switcher 20, the side fences 24L and 24R, the contact-separation motor 32d, the crimper pivot motor 56, the liquid applier movement motor 37, the liquid-applier pivot motor 563, the edge-binder moving motor 50, the stapler drive motor 62d, the stapler pivot motor 82, and the staple binder movement motor 80. The controller 100b acquires detection results from the movement sensor 40a, the liquid level sensor 43a, the standby-position sensor 540, and the encoder sensor 541. Although FIG. 6 illustrates only the components related to the edge binder 25 and the staple binder 55 that perform the edge binding, the components related to the saddle binder 28 that performs the saddle binding are also controlled by the controller 100b.

As illustrated in FIG. 1, the image forming apparatus 2 includes the operation panel 110. The operation panel 110 includes an operation section that receives instructions input by an operator and a display (which is an example of a notifier) that notifies the operator of information. The operation section includes, for example, hard keys and a touch screen overlaid on the display. The operation panel 110 acquires information from the operator through the operation section and provides information to the operator through the display. A specific example of the notifier is not limited to the display and may be a light-emitting diode (LED) lamp or a speaker. The post-processing apparatus 3 may include an operation panel similar to the above-described operation panel 110 of the image forming apparatus 2.

As described above, the post-processing apparatus 3 according to the present embodiment includes the edge binder 25 that can perform the post-processing such as the crimp binding process and the staple binding process after the liquid application process. When the number of sheets P of the sheet bundle Pb is small, the edge binder 25 can also perform the crimp binding process without applying liquid (that is, only the crimp binder 32 performs the crimp binding process), as in the crimp binding process in the art.

In the edge binder 25, the crimping teeth slider 322 and/or the edge-binder movement assembly 47 can move the liquid applier 31 and the crimp binder 32 in the main scanning direction. Due to such a configuration, the liquid application position of the liquid applier 31 and/or the binding position of the crimper 32 can be moved in the main scanning direction to perform multiple crimp binding processes. As a result, the crimp binding processes performed by the upper crimping teeth 32a and the lower crimping teeth 32b can form crimping marks adjacent to each other to increase the binding strength of the sheet bundle Pb.

The following describes a method to change the number of repetitions of the crimp binding processes on one sheet bundle Pb (hereinafter, referred to as the “number of crimp binding” and methods of the binding processes (the post-processing) according to binding conditions such as the number of sheets P of the sheet bundle Pb to be subjected to the binding process (the post-processing) and the binding posture of the crimp binder 32 with respect to the sheet bundle Pb.

A description is given of a binding process.

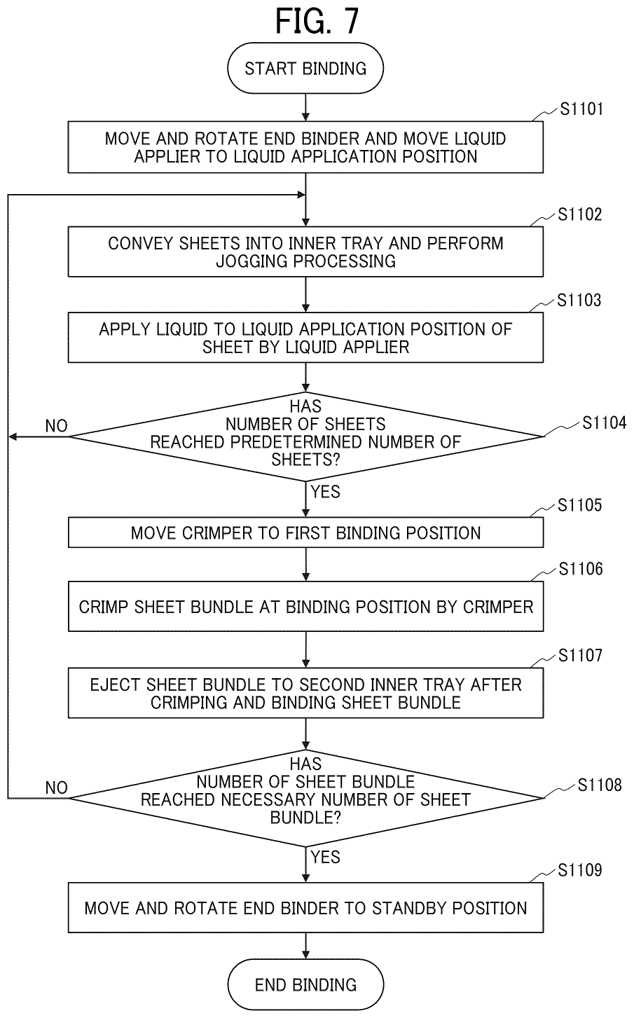

Specifically, a description is given below of a binding process executed by the edge binder 25 included in the post-processing apparatus 3. FIG. 7 is a flowchart of a process of one-point binding performed by the edge binder 25. FIGS. 8A, 8B, 8C, and 8D are diagrams each illustrating the positions of the edge binder 25 (the liquid applier 31 and the crimp binder 32) during the one-point binding. FIGS. 8A, 8B, 8C, and 8D do not illustrate changes in the postures of the liquid applier 31 and the crimp binder 32. The position, i.e., the liquid application position, to which liquid is applied on a sheet P or a sheet bundle Pb by the liquid applier 31 corresponds to the binding position on the sheet bundle Pb to be crimped by the crimp binder 32.

For example, the controller 100b starts the binding process illustrated in FIG. 7 when the controller 100b acquires an instruction to execute the binding process from the image forming apparatus 2. In the following description, the instruction to execute the binding process may be referred to as a “binding command.”

The binding command includes, for example, the type of the sheet P (including information affecting the spread of liquid, such as material and thickness), the number of sheets P of the sheet bundle Pb, the number of sheet bundles Pb to be bound, the binding position on the sheet bundle Pb, and the binding posture of the edge binder 25. In the following description, the number of sheets P of the sheet bundle Pb may be referred to as “given number of sheets N” whereas the number of sheet bundles Pb to be bound may be referred to as “requested number of copies M.”

As illustrated in FIG. 8A, the liquid applier 31 and the crimp binder 32 are in a parallel binding posture and located at the standby position HP shifted in the width direction from the sheets P supported on the internal tray 22 at the start of the binding process.

When the posture that is instructed by the binding command is “inclined binding posture,” in step S1101, the controller 100b drives the liquid-applier pivot motor 563 and the crimper pivot motor 56 to rotate the liquid applier 31 and the crimp binder 32 of the edge binder 25 into an oblique binding posture. When the posture that is instructed by the binding command is the “inclined binding posture,” the crimp binder 32 alone may be pivoted to the inclined binding posture and the liquid applier 31 may not be pivoted in the forward and reverse directions. Such a configuration can simplify the drive mechanism as compared with a configuration in which both the liquid applier 31 and the crimp binder 32 are rotated in the forward and reverse directions. Thus, the effects of cost reduction, the downsizing of the apparatus, and the reduction of a failure of devices are obtained.

On the other hand, when the posture that is instructed by the binding command is the “parallel binding posture,” the controller 100b omits the aforementioned operation of rotating the liquid applier 31 and the crimp binder 32 of the edge binder 25 to the oblique binding posture.

In step S1101, the controller 100b drives the edge-binder moving motor 50 to move the edge binder 25 in the main scanning direction such that the liquid applier 31 faces a first liquid application position B1 instructed by the binding command. The controller 100b executes the operation of step S1101 before a first sheet P is conveyed to the internal tray 22 by the conveyance roller pairs 10, 11, 14, and 15.

In step S1102, the controller 100b rotates the conveyance roller pairs 10, 11, 14, and 15 to store the sheet P, on which the image has been formed by the image forming apparatus 2, onto the internal tray 22. In step S1102, the controller 100b also moves the side fences 24L and 24R in the main scanning direction to align the position of the sheet P or the sheet bundle Pb supported on the internal tray 22 in the main scanning direction. In short, the controller 100b performs so-called jogging.

In step S1103, the controller 100b causes the liquid applier 31 facing the first liquid application position B1 to apply liquid to the first liquid application position B1 of the sheet P supported on the internal tray 22 in the immediately preceding step S1102, based on the liquid application control data adjusted in advance. In other words, the controller 100b drives the liquid-application-unit movement motor 42 to bring the liquid applier 31 into contact with the liquid application position BI on the sheet P supported on the internal tray 22 (see FIG. 8B). In the liquid application process in step S1103, the controller 100b adjusts the position at which the liquid applier 31 applies liquid to the sheet P in accordance with the type of the sheet P and the binding position included in the binding command. The controller 100b adjusts the amount of pressing the liquid applier 31 against the sheet P. In other words, the controller 100b controls the driving of the liquid-application-unit movement motor 42 based on the adjusted control data, and adjusts the amount of movement of the liquid applier 31 with respect to the first liquid application position B1 of the sheet P supported on the internal tray 22.

In step S1104, the controller 100b determines whether the number of sheets P supported on the internal tray 22 has reached the given number of sheets N instructed by the binding command. When the controller 100b determines that the number of sheets P supported on the internal tray 22 has not reached the given number of sheets N (NO in step S1104), the controller 100b executes the operations of steps S1102 to S1104 again until the number of sheets P supported on the internal tray 22 reaches the given number of sheets N (YES in step S1104). In other words, the controller 100b executes the processing of steps S1102 to S1104 each time the sheet P is conveyed to the internal tray 22 by the conveyance roller pairs 10, 11, 14, and 15. The liquid application by the liquid applier 31 may be performed not only on all of the multiple sheets P included in the sheet bundle Pb but also on only some of the multiple sheets P included in the sheet bundle Pb.

When the controller 100b determines that the number of sheets P supported on the internal tray 22 has reached the given number of sheets N (YES in step S1104), as illustrated in FIG. 8C, the controller 100b drives the edge-binder moving motor 50 to move the edge binder 25 in the main scanning direction so that the crimp binder 32 faces the first binding position B1 (step S1105).

In step S1106, the controller 100b causes the crimp binder 32 to crimp the sheet bundle Pb supported on the internal tray 22. In step S1107, the controller 100b causes the conveyance roller pair 15 to eject the sheet bundle Pb thus crimped and bound by the crimp binder 32 to the second output tray 26. More specifically, the controller 100b drives the contact-separation motor 32d to cause the upper crimping teeth 32a and the lower crimping teeth 32b to clamp the first binding position B1 on the sheet bundle Pb supported on the internal tray 22. The sheet bundle Pb is pressed and deformed between the upper crimping teeth 32a and the lower crimping teeth 32b, thus the sheet bundle Pb is crimped. Then, the controller 100b rotates the conveyance roller pair 15 to eject the sheet bundle Pb thus crimped and bound to the second output tray 26.

The sheet bundle Pb that is supported on the internal tray 22 has a crimping area, which corresponds to the first binding position B1, sandwiched between the upper crimping teeth 32a and the lower crimping teeth 32b in step S1106. The crimping area overlaps the liquid application area, which corresponds to the first liquid application position B1, contacted by a distal end of the liquid applier 31 in step S1103. In other words, the crimp binder 32 crimps an area to which liquid is applied by the liquid applier 31 on the sheet bundle Pb supported on the internal tray 22. The crimping area that is sandwiched by the upper crimping teeth 32a and the lower crimping teeth 32b may completely or partially overlap with the liquid application area contacted by the distal end of the liquid applier 31, to obtain a sufficient binding strength.

In step S1108, the controller 100b determines whether the number of sheet bundle Pb thus ejected to the second output tray 26 has reached the requested number of copies M indicated by the binding command. When the controller 100b determines that the number of sheet bundles Pb thus ejected has not reached the requested number of copies M (NO in step S1108), the controller 100b executes the operations of step S1102 and the following steps again. In other words, when the controller 100b determines that the number of sheet bundles Pb thus ejected has not reached the requested number of copies M (NO in step S1108), the controller 100b repeats the operations of steps S1102 to S1108 until the number of sheet bundles Pb ejected to the second output tray 26 reaches the requested number of copies M.

On the other hand, when the controller 100b determines that the number of sheet bundles Pb ejected to the second output tray 26 has reached the requested number of copies M (YES in step S1108), in step S1109, the controller 100b drives the edge-binder moving motor 50 to move the edge binder 25 (the liquid applier 31 and the crimp binder 32) to the standby position HP as illustrated in FIG. 8D. When the posture that is instructed by the binding command is the oblique binding posture, in step S1109, the controller 100b drives the liquid-applier pivot motor 563 and the crimper pivot motor 56 to rotate the liquid applier 31 and the crimp binder 32 into the parallel binding posture. On the other hand, when the posture that is instructed by the binding command is the parallel binding posture, the controller 100b skips the aforementioned operation of rotating the liquid applier 31 and the crimp binder 32 to the parallel binding posture. As a result, the edge binder 25 (the liquid applier 31 and the crimp binder 32) returns to the standby position HP illustrated in FIG. 8D. In steps S1101 and S1109, the execution order of the movement in the main scanning direction and the rotation in the forward and reverse directions of the liquid applier 31 and the crimp binder 32 is not limited to the aforementioned order and may be reversed.

### Second Embodiment

The post-processing apparatus 3 according to a second embodiment of the present disclosure is described below with reference to FIGS. 9 to 12. A detailed description of points that are similar to the first embodiment is omitted, and points that are different from the first embodiment are mainly described below. The basic configuration of the post-processing apparatus 3 according to the second embodiment is similar to that of the first embodiment, and is different from the first embodiment in that the post-processing apparatus 3 of the second embodiment further includes a crease former 90.

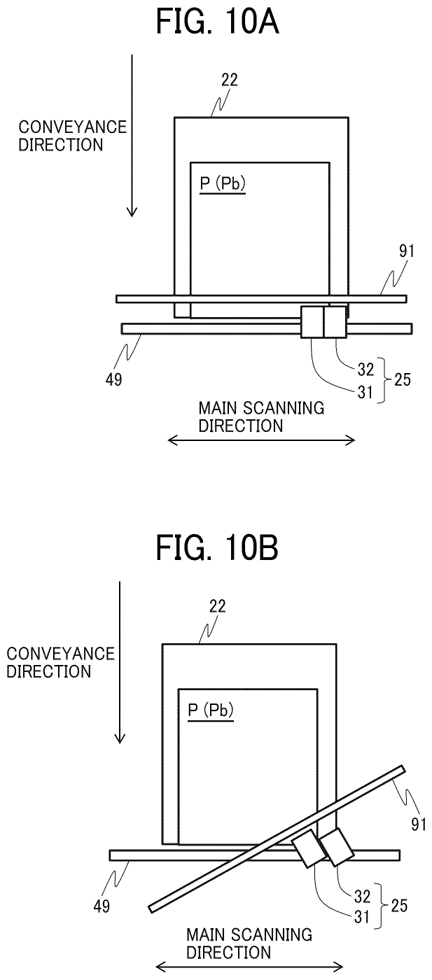

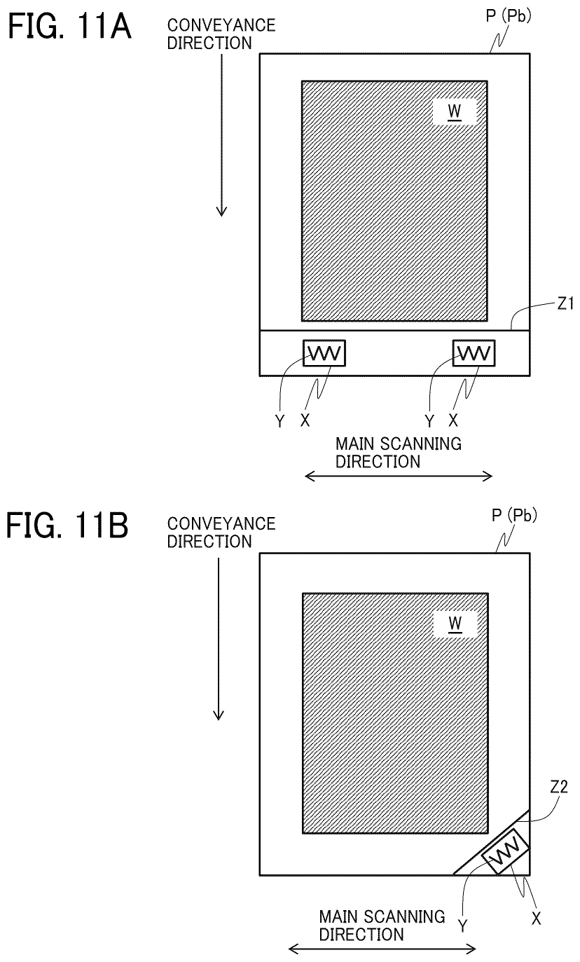

FIG. 9 is a schematic diagram illustrating a liquid applier 31 of the edge binder 25 of the second embodiment, viewed from the main scanning direction. FIGS. 10A and 10B are diagrams each illustrating the internal tray 22, the edge binder 25, and the crease former 90 including a blade 91 viewed from the thickness direction of the sheet P. FIGS. 11A and 11B are diagrams each illustrating relative positions of an image forming area W, a liquid application area X, a crimp binding area Y, and creases Z1 and Z2.

The crease former 90 is a unit that forms the creases Z1 and Z2 on the multiple sheets P supported on the internal tray 22. As illustrated in FIGS. 9, 10A, and 10B, the crease former 90 typically includes the blade 91 and a bracket 92. The creases Z1 and Z2 are streak-shaped (typically, linear) portions formed on the sheets P by pressing the sheets P in the thickness direction. As illustrated in FIGS. 11A and 11B, the creases Z1 and Z2 extend in the longitudinal direction of the rectangular liquid application area X (in other words, the crimp binding area Y) in the parallel binding and the oblique binding.

The crease former 90 may have a function of forming the creases Z1 and Z2 on each of the multiple sheets P supported on the internal tray 22, and may not form the creases Z1 and Z2 on all of the sheets P of the sheet bundle Pb in the binding process. As an example, the crease former 90 may form the creases Z1 and Z2 on the odd-numbered (or even-numbered) sheets P of the sheet bundle Pb. As another example, the crease former 90 may form the creases Z1 and Z2 on sheets P to which the liquid applier 31 (liquid application device) applies the liquid. In other words, the crease former 90 may form the creases Z1 and Z2 at a similar frequency (rate) as the liquid applier 31 applies the liquid to the multiple sheets P of the sheet bundle Pb.

The blade 91 is a substantially rectangular flat plate member. The blade 91 has a blade portion 94 on one of sides constituting the outer periphery of the blade 91. The blade portion 94 is tapered toward the tip end of the blade 91 and extends linearly along longitudinal sides of the blade 91. The length of the blade portion 94 is set to be longer than the maximum width of the sheet P that can be placed on the internal tray 22.

As illustrated in FIG. 9, the blade 91 is supported by the liquid applier 31 (more specifically, the base plate 40) via the bracket 92. The blade 91 is supported by the liquid applier 31 when the blade portion 94 faces the internal tray 22 (more specifically, the sheets P supported on the internal tray 22). The blade 91 moves in a direction in which the blade portion 94 contacts and separates from the sheets P supported on the internal tray 22 together with the base plate 40, i.e., the upper pressure plate 34, by the driving force of the liquid applier movement motor 37 transmitted to the blade 91.

As illustrated in FIG. 10, the blade 91 rotates integrally with the liquid applier 31 around the liquid applier rotary shaft 562. The driving force of the liquid-applier pivot motor 563 is transmitted to the blade 91. By so doing, the blade 91 rotates around the liquid applier rotary shaft 562 between a first posture illustrated in FIG. 10A and a second posture illustrated in FIG. 10B.

As illustrated in FIGS. 10A and 11A, the first posture is a posture in which the blade 91 forms the crease Z1 orthogonal to the conveyance direction of the sheet P with respect to the internal tray 22. In other words, the first posture is a posture of the blade 91 in which the blade portion 94 extends in the main-scanning direction. In other words, the first posture is a posture of the blade 91 in which the blade 91 forms the crease Z1 connecting a pair of sides extending in the conveyance direction (in other words, facing each other in the main-scanning direction) among four sides of the rectangular sheet P.

As illustrated in FIGS. 10B and 11B, the second posture is a posture of the blade 91 in which the blade 91 forms the crease Z2 inclined with respect to the conveyance direction of the sheet P supported on the internal tray 22. In other words, the second posture is a posture of the blade 91 in which the blade portion 94 is inclined with respect to the main-scanning direction. In other words, the second posture is a posture of the blade 91 in which the blade 91 forms the crease Z2 connecting adjacent sides (more specifically, a first side extending in the main-scanning direction downstream in the conveyance direction and a second side extending in the conveyance direction adjacent to the first side) among the four sides of the rectangular sheet P.

A description is given below of an operation of the crease former 90.

The controller 100b causes the crease former 90 to switch between the first posture and the second posture in accordance with the rotation of the liquid applier 31 in steps S1101 and S1109 of FIG. 7. In addition, the controller 100b causes the blade 91 to form the creases Z1 and Z2 on the sheets P supported on the internal tray 22 in parallel while the liquid applier 31 applies the liquid to the sheet P in step S1103 of FIG. 7. In other words, the crease former 90 forms the creases Z1 and Z2 on a first position of the sheet bundle Pb for each of the sheets P on the sheets P before the crimp binder 32 as a crimp binder crimps and binds the sheet bundle Pb in step S1106, at a second position exterior of the first position of the sheet bundle Pb. In still other words, the crimp binder binds the sheet bundle Pb at the second position after the crease former 90 forms the creases Z1 and Z2 on each sheet P of the sheet bundle Pb on the first position of the sheet bundle Pb. In other words, the crimp binder 32 crimps and binds the sheet bundle Pb to which the liquid has been applied by the liquid applier 31 and on which the creases ZI and Z2 have been formed by the crease former 90.

As illustrated in FIGS. 11A and 11B, the crease former 90 forms the fold marks Z1 and Z2 in an area different from the liquid application area X to which the liquid is applied by the liquid applier 31 and the crimp binding area Y to which the sheets P are crimped and bound by the crimp binder 32. By contrast, the liquid application area X and the crimp binding area Y overlap each other. In other words, the crimp binder 32 crimps and binds the liquid application area X of the sheet bundle Pb.

Further, the creases Z1 and Z2 are formed between the image forming area W in which the image is formed by the image forming apparatus 2, and the liquid application area X and the crimp binding area Y. In other words, the liquid applier 31 applies the liquid to an area (in other words, a margin area) on the opposite side of the image forming area W across the creases Z1 and Z2, on the front side of the sheets P supported on the internal tray 22.

Similarly, the crimp binder 32 crimps and binds an area, i.e., the margin area, opposite the image forming area W across the creases Z1 and Z2 on the front side of the sheet bundle Pb supported on the internal tray 22. Further, preferably, the crease former 90 forms the creases Z1 and Z2 outside the image forming area W, i.e., the margin area.

A description is given below of a functional effect of the crease former 90 according to the second embodiment.

The crease former 90 of the second embodiment forms the creases Z1 and Z2 before the crimp binder 32 performs the crimp binding. Accordingly, the crease former 90 can form the creases Z1 and Z2 also on sheets P of an inner side of the sheet bundle Pb. Thus, even when the sheets P on the inner side of the sheet bundle Pb are turned over, the sheets P can be prevented from being peeled off from the sheet bundle Pb. In addition, the crease former 90 of the second embodiment forms the creases Z1 and Z2 on the sheets P supported on the internal tray 22. Accordingly, the production efficiency of the post-processing apparatus 3 can be prevented from decreasing compared with a case in which the sheets P are stopped on the conveyance paths Ph1 and Ph2 to form the creases Z1 and Z2.

The crease former 90 of the second embodiment switches the posture of the blade 91. By so doing, the crease former 90 can form the creases Z1 and Z2 in appropriate directions in both the parallel binding and the oblique binding. Accordingly, the load that is applied to the sheet bundle Pb in the direction in which the operator naturally turns the sheets P can be reduced.

In addition, according to the second embodiment, the crease former 90 is attached to the liquid applier 31. Accordingly, the blade portion 94 can be brought into contact with and separated from the sheets P by the driving force of the liquid applier movement motor 37, and the posture of the blade 91 can be changed by the driving force of the liquid-applier pivot motor 563. Such a configuration can prevent the number of components of the post-processing apparatus 3 from increasing and obtain the above-described effects.

### Modifications of Second Embodiment

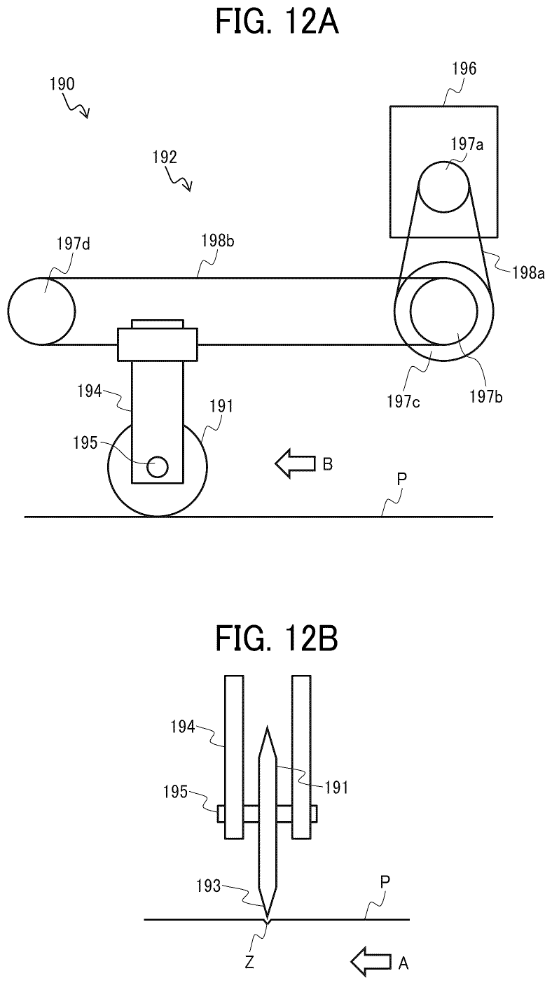

FIGS. 12A and 12B are diagrams each illustrating a crease former 190 according to a modification of the second embodiment. More specifically, FIG. 12A is a diagram illustrating the crease former 190 according to the modification, viewed from a direction A (see FIG. 12B) orthogonal to a direction in which a crease Z extends. FIG. 12B is a diagram illustrating the crease former 190 according to the modification, viewed from a direction B (see FIG. 12A) in which the crease Z extends. The detailed description of points that are similar to the second embodiment is omitted, and points that are different from the second embodiment are mainly described below. As illustrated in FIG. 12A, the crease former 190 according to the modification typically includes a disk 191 and a moving mechanism 192.

The disk 191 has a substantially disk-shaped outer shape. The outer edge of the disk 191 is tapered toward the outer circumferential surface of the disk 191 to form a blade portion 193. In other words, the blade portion 193 is formed continuously in the circumferential direction on the outer circumferential surface of the disk 191.

The moving mechanism 192 is supported by the liquid applier 31. The moving mechanism 192 rotatably supports the disk 191. In addition, the moving mechanism 192 moves the disk 191 along the surface of the sheet P supported on the internal tray 22. The moving mechanism 192 includes, for example, a bracket 194, a rotary shaft 195, a disk moving motor 196, pulleys 197a, 197b, 197c, and 197d, and endless annular belts 198a and 198b.

The bracket 194 has a base end fixed to the endless annular belt 198b and a distal end to rotatably support the disk 191 via the rotary shaft 195. The rotary shaft 195 extends in a direction orthogonal to the direction in which the crease Z extends and is fixed to the distal end of the bracket 194. The rotary shaft 195 penetrates the center of the disk 191 in the thickness direction. Thus, the disk 191 is rotatable around the rotary shaft 195.

The disk moving motor 196 generates a driving force for moving the bracket 194 (in other words, the disk 191). The pulley 197a is attached to the output shaft of the disk moving motor 196. The pulley 197b is disposed at a position away from the pulley 197a. The pulley 197c rotates integrally with the pulley 197b. The pulley 197d is disposed at a position away from the pulley 197c in the direction in which the crease Z extends. The endless annular belt 198a is wound around the pulleys 197a and 197b. The endless annular belt 198b is wound around the pulleys 197c and 197d.

The pulley 197a is rotated by the driving force of the disk moving motor 196. By so doing, the endless annular belt 198a circulates around the pulleys 197a and 197b. Accordingly, the pulleys 197b and 197c rotate. The endless annular belt 198b is circulated between the pulleys 197c and 197d by the rotation of the pulley 197c. Accordingly, the bracket 194 that is attached to the endless annular belt 198b moves together with the disk 191. The disk moving motor 196 rotates while the disk 191 contacts and pressed against the surface of the sheet P supported on the internal tray 22. Accordingly, the disk 191 moves while rotating. As a result, the crease Z is formed on the front surface of the sheets P.

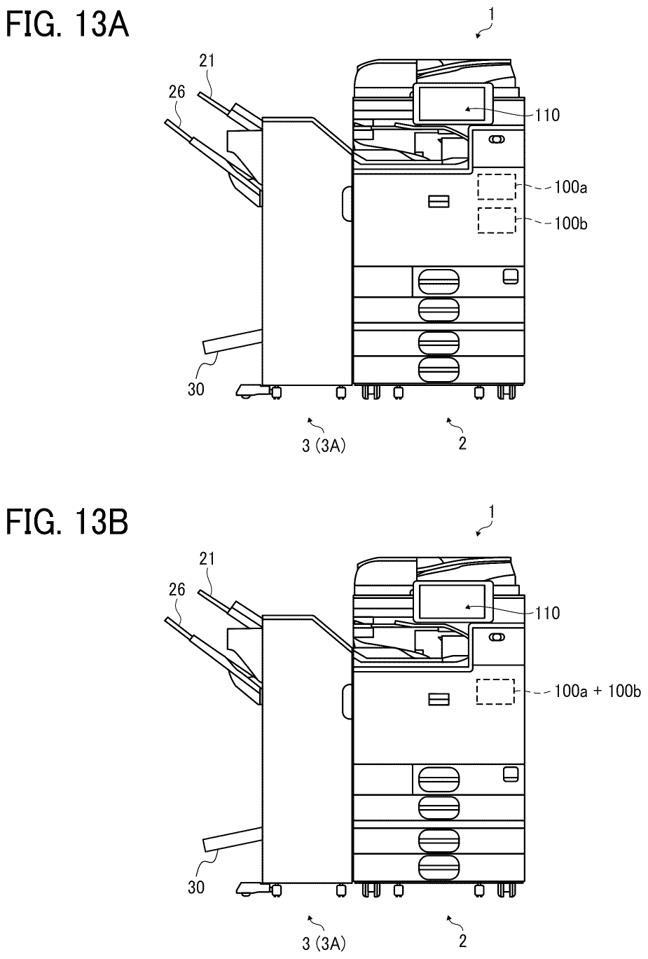

In the above description, the controller 100b of the post-processing apparatus 3 is provided separately from the controller 100a of the image forming apparatus 2 as illustrated in FIG. 1. However, embodiments of the present disclosure are not limited to the above-described configuration. For example, as illustrated in FIG. 13A, the controller 100b of the post-processing apparatus 3 may be disposed in the image forming apparatus 2. Further, as illustrated in FIG. 13B, the controller 100b of the post-processing apparatus 3 may be integrated with the controller 100a of the image forming apparatus 2.

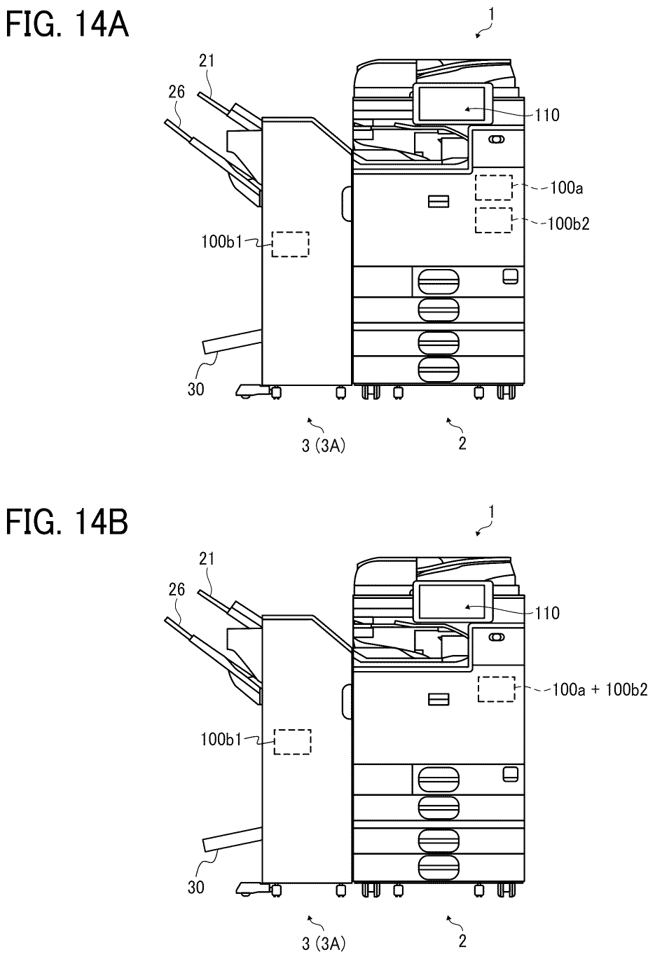

As illustrated in FIG. 14A, the controller 100b of the post-processing apparatus 3 may be divided into a controller 100b1 (e.g., a drive unit such as a motor) and a controller 100b2 (a detector such as a sensor) according to the function, and the controller 100b2 of the post-processing apparatus 3 may be disposed in the image forming apparatus 2. Further, as illustrated in FIG. 14B, the controller 100b2 of the post-processing apparatus 3 disposed in the image forming apparatus 2 may be integrated with the controller 100a of the image forming apparatus 2.

### Aspects of the Present Disclosure

Aspects of the present disclosure are, for example, as follows.

### First Aspect

A medium processing apparatus includes a tray, a crimp binder to press and deform multiple media supported on the tray to crimp and bind multiple media, and a crease former to form a crease on each of the multiple media supported on the tray before the crimp binder crimps and binds the multiple media.

### Second Aspect

The medium processing apparatus according to the first aspect, further includes a conveyor to convey the medium to the crease former in a conveyance direction. The crease former is movable between a first posture in which the crease former forms the crease orthogonal to the conveyance direction on the medium and a second posture in which the crease former forms the crease inclined with respect to the conveyance direction on the medium.

### Third Aspect

In the medium processing apparatus according to the first or second aspect, the crease former includes a blade extending linearly along a surface of the medium supported on the tray, and the blade is separably contactable with the medium.

### Fourth Aspect

In the medium processing apparatus according to the first or second aspect, the crease former further includes a disk, a blade portion, and a moving mechanism. The disk has a rotary shaft, around which the disk is rotatable, and the rotary shaft is arranged orthogonal to a thickness direction of the multiple media. The blade portion is continuous on an outer circumferential surface of the disk in a circumferential direction. The moving mechanism supports the rotary shaft and move the disk along a surface of the medium.

### Fifth Aspect

The medium processing apparatus according to any one of the first to fourth aspect, further includes a liquid applier to apply liquid to the medium of the multiple media on the tray. The liquid applier supports the crease former to form the crease on the medium of the multiple media while the liquid applier applies the liquid to the medium of the multiple media. The crimp binder crimps and binds the multiple media to which the liquid is applied by the liquid applier and the crease is formed by the crease former.

### Sixth Aspect

In the medium processing apparatus according to any one of the first to fifth aspect, the crease former forms a crease in an area, i.e., a first area of the multiple media on the tray. The crimp crimps and binds the multiple media in an area, i.e., a second area different from the first area of the multiple media on the tray.

### Seventh Aspect

An image forming system includes an image forming apparatus to form an image on a medium, and the medium processing apparatus according to any one of the first to sixth aspect.

### Eighth Aspect

In the image forming system according to the seventh aspect, the crimp binder presses and binds an area on the surface of the multiple media opposite an area in which an image is formed by an image forming apparatus across the crease formed by the crease former.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A medium processing apparatus comprising:
a tray to stack multiple media including a medium;
a crimp binder to crimp and bind the multiple media on the tray; and
a crease former to form a crease on each of the multiple media on the tray before the crimp binder crimps and binds the multiple media.

2. The medium processing apparatus according to claim 1, further comprising:
a conveyor to convey the medium to the crease former in a conveyance direction,
wherein the crease former is movable between:
a first posture in which the crease former forms the crease orthogonal to the conveyance direction on the medium; and
a second posture in which the crease former forms the crease inclined with respect to the conveyance direction on the medium.

3. The medium processing apparatus according to claim 1,
wherein the crease former includes a blade extending linearly along a surface of the medium supported on the tray, and
the blade is separably contactable with the medium.

4. The medium processing apparatus according to claim 1,
wherein the crease former further includes:
a disk having a blade portion continuous on an outer circumferential surface of the disk in a circumferential direction; and
a moving mechanism (192) having a rotary shaft, around which the disk is rotatable,
the rotary shaft is arranged orthogonal to a thickness direction of the multiple media, and
the moving mechanism moves the disk along a surface of the medium.

5. The medium processing apparatus according to claim 1, further comprising a liquid applier to apply liquid to the medium of the multiple media on the tray,
wherein the liquid applier supports the crease former to form the crease on the medium of the multiple media while the liquid applier applies the liquid to the medium of the multiple media, and
the crimp binder crimps and binds the multiple media including the media applied with the liquid by the liquid applier and having the crease formed by the crease former.

6. The medium processing apparatus according to claim 1,
wherein the crease former forms a crease in a first area of the multiple media on the tray,
the crimp crimps and binds the multiple media in a second area different from the first area of the multiple media on the tray.

7. An image forming system comprising:
an image forming apparatus to form an image on a medium; and
the medium processing apparatus according to claim 1.

8. The image forming system according to claim 7,
wherein the crimp binder presses and binds an area on a surface of the multiple media opposite an area in which an image is formed by an image forming apparatus across the crease formed by the crease former.

9. The medium processing apparatus according to claim 1,
wherein the crease former forms the crease on a first position of the multiple media for each of the multiple media, and
the crimp binder binds the multiple media at a second position exterior of the first position of the multiple media after the crease former forms the crease on each of the multiple media.
